(19) United States
(12) Patent Application Publication
(10) Pub. No.: US 2016/0110942 A1
(43) Pub. Date: Apr. 21, 2016

(54) GAMING TABLE

(71) Applicant: Ideal Designs Inc., Howell, MI (US)

(72) Inventors: Andrew H. STEVERS, Howell, MI (US); David J. EPSTEIN, Howell, MI (US); David A. GRAMMER, II, Westland, MI (US)

(21) Appl. No.: 14/882,639

(22) Filed: Oct. 14, 2015

Related U.S. Application Data
(60) Provisional application No. 62/065,227, filed on Oct. 17, 2014.

(51) Int. Cl. G07F 17/32

(52) U.S. Cl. CPC G07F 17/322; G07F 17/3241; G07F 17/3293

(57) ABSTRACT

A gaming table includes a playing surface having a plurality of player stations with each of the player stations having an indicator device that can be activated. A processor unit and at least one input device associated with the processor unit is provided for selectively activating the indicator devices at each player station in order to represent game related information.

### CROSS-REFERENCE TO RELATED APPLICATIONS

This application claims the benefit of U.S. Provisional Application No. 62/065,227, filed Oct. 17, 2014. The entire disclosure of the above application is incorporated herein by reference.

### FIELD

The present disclosure relates to a gaming table for card games and more particularly to a gaming table having indicators for communicating information relevant to the game.

### BACKGROUND

This section provides background information related to the present disclosure which is not necessarily prior art.

In some card games a “dealer button” (also known as a dealer puck) is used as a marker to identify who the dealer is in a hand or, in casino games with a house dealer, the player who acts last on that deal. If a player has the dealer button in front of him, he is said to be “on the button”. After a hand is dealt, the dealer button is passed to the players left so everyone knows who is dealing the next hand. The identification of the dealer is important because it can affect the order in which the cards are dealt and the order in which bets are made. The term “button” is often used to refer to the dealer position, which is the position whose turn to bet comes last. Being “on the button” is therefore the most advantageous and most profitable position in poker.

Today, a dealer button is typically a white plastic disc with the word “Dealer” on each side. While in home games the player holding the dealer button deals the cards, in casino poker, a casino employee handles this responsibility.

The dealer button is sometimes modified to indicate a secondary detail about the hand being played—for example, a kill game may use a button with the word “Kill” on one side to show that the current hand is a kill pot, and the button can be turned with the “Dealer” side up to show that the kill is off, or a dealer's choice game might replace the dealer button with a placard indicating the chosen game.

In casino and card room cash games, the dealer's well may contain an assortment of laminated discs that the dealer may place in front of a player's seat under certain conditions. Properly called lammers, but also referred to as buttons, they are separate from and used differently from a dealer button.

In card games that use a dealer button, a common problem is that the dealer button is not passed to the correct position. When this happens, the dealer may deal cards to the wrong players resulting in a misdeal. Misdeals are annoying to the players and to casino managers who want their dealers to maintain efficiently run card games.

Other issues that can arise at casinos and poker tournaments is that the card games can go on for several hours during which the players typically desire to maintain their mobile phones and other electronic devices charged for communication and other entertainment purposes. Casinos and other facilities that host poker tournaments typically do not maintain a sufficient number of wall or floor outlets to allow players to charge their phones and other devices within a close proximity to the table where they are playing.

### SUMMARY

This section provides a general summary of the disclosure, and is not a comprehensive disclosure of its full scope or all of its features.

The present disclosure replaces the “dealer button” with an indicator that can include electronically controlled lights, LEDs, a video monitor or other indicator device. A gaming table according to the present disclosure includes a playing surface having a plurality of player stations with each of the player stations having an indicator device that can be activated. A processor unit and at least one input device associated with the processor unit are provided for selectively activating the indicator devices at each player station to indicate which player is “on the button” or other game related information. The gaming table can be a poker table.

According to a further aspect of the present disclosure, a gaming table includes a playing surface having a plurality of player stations with each of the player stations having a charging port implemented in the gaming table for allowing a player to charge an electronic device at the gaming table.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a gaming table having indicator lights according to the principles of the present disclosure;

FIG. 2 is a top plan view of the gaming table shown in FIG. 1;

FIG. 3 is a plan view of a dealer control panel having optional chip trays integrated therewith;

FIG. 4 is a bottom plan view of the gaming table shown in FIG. 1;

FIG. 5 is a close-up perspective view of a charging port that can be used for charging cell phones and other electronic devices at each station of the gaming table; and

FIG. 6 is a schematic diagram of an electronic circuit for controlling the indicator according to the principles of present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

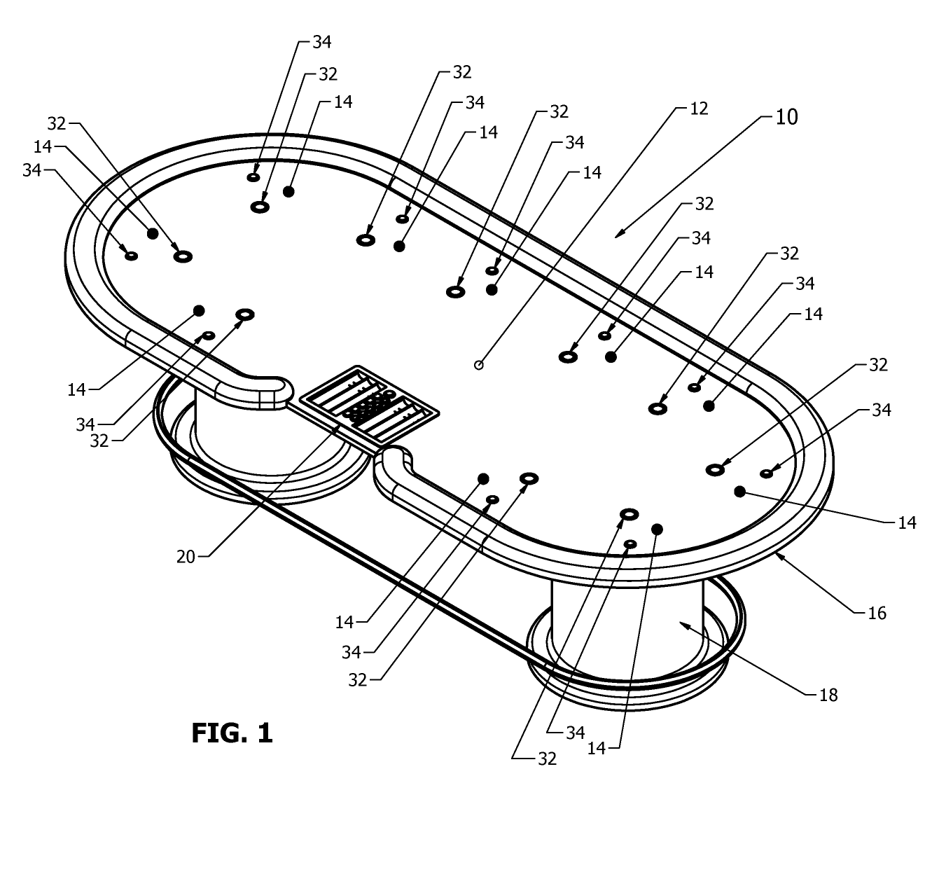

With reference to FIG. 1, a gaming table 10 according to the principles of the present disclosure is shown in the form of a poker table. Although the gaming table 10 will be described herein with reference to the specifically disclosed poker table, it should be understood that the principles disclosed herein can be applied to other gaming tables such as blackjack and other card game tables. The gaming table 10 includes a playing surface 12 having a plurality of player stations 14 (10 of which are shown). The playing surface 12 can be surrounded by a rail 16 that can be padded and slightly raised for the players to rest their arms. The playing surface 12 can be covered with a felt, cloth or other fabric that helps the cards slide easily across the surface. The playing surface 12 can be oval, round, octagonal, rectangular or other desired shapes. The playing surface 12 can be supported by a base 18 in the form of one or more legs or pedestals. The playing surface 12 can also be provided with a dealer station 20.

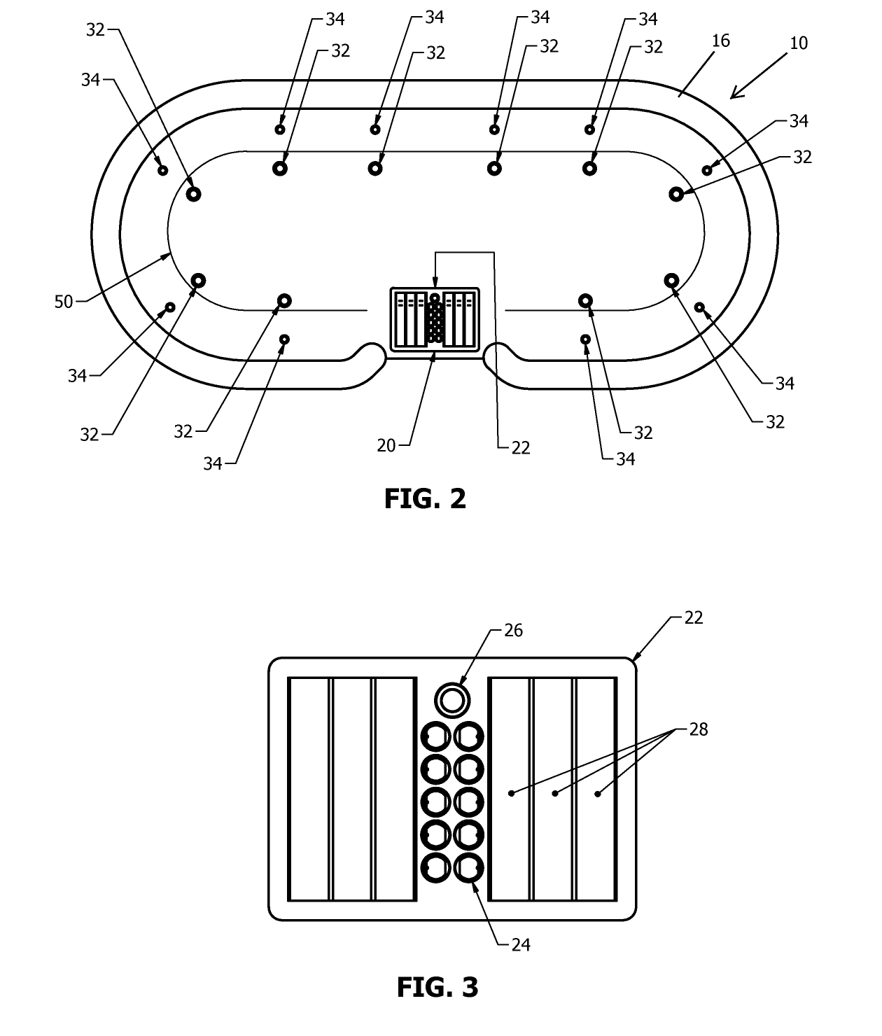

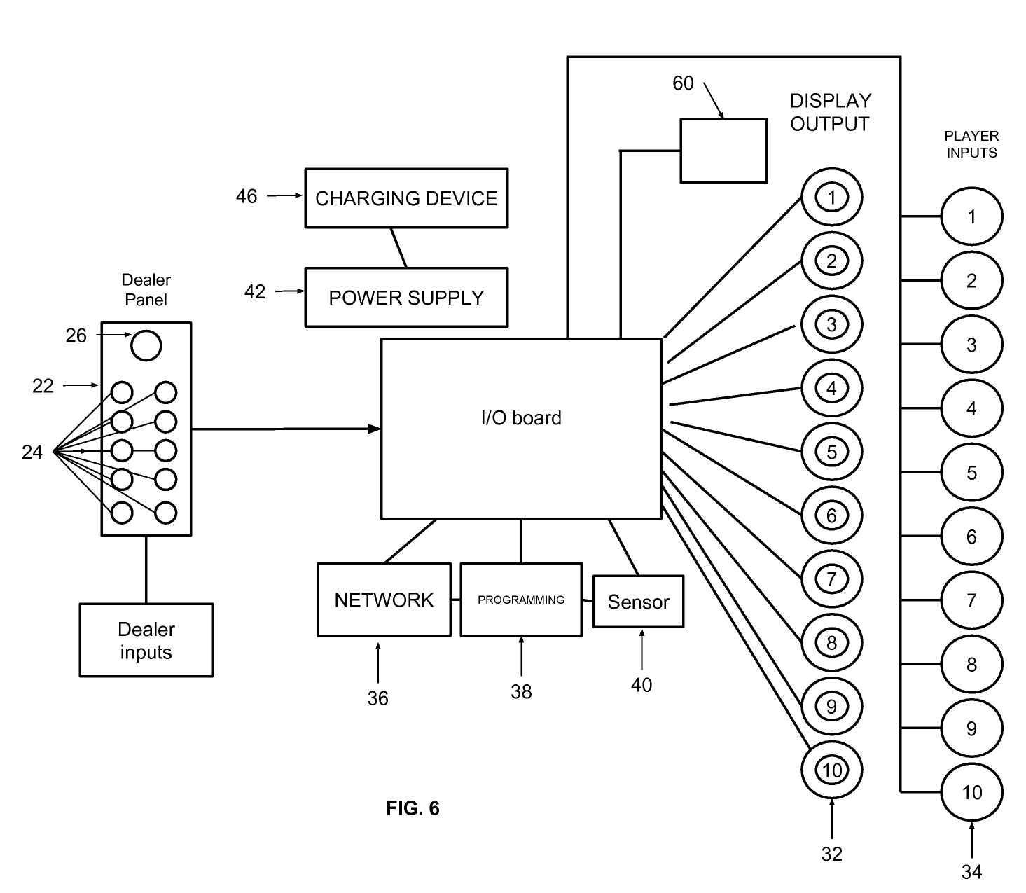

With reference to FIGS. 2 and 3, the dealer station 20 can be provided with a dealer control panel 22 that can include a plurality of active player switches 24 and an index button 26. The dealer control panel 22 can further include a plurality of chip trays 28 that are capable of storing a plurality of chips therein. As shown in FIG. 6, the dealer control panel 22 is provided in communication with a central processor unit 30 that can be electrically connected to a plurality of display outputs 32₁₋₁₀, one each for each player station 14 (10 of which are shown). As shown in FIGS. 1 and 2, the plurality of display outputs 32₁₋₁₀ can be provided on the playing surface 12 or another location on the gaming table 10 including the rail 14, preferably, on or near a bet line as ordinarily understood in the game of poker whether printed on the playing surface or implied. The central processor unit 30 can also optionally be connected to a plurality of player inputs 34₁₋₁₀ which can also be provided on the playing surface 12 or at another location on the gaming table 10. The player inputs 34₁₋₁₀ and index button 26 can be in the form of a single push button, a toggle switch, a multi-key pad, a programmable touch screen or other known input device. In the case of a multi-key pad or a programmable touch screen, the central processor unit can assign each key or each touch screen with different functions and/or displays for different games and for performing different functions during a game. The index button 26 or other dealer input button can allow the dealer to change the light colors of the display outputs 32 or to reverse the movement of the lights and allow change of other light controls. It is anticipated that the display output 32 and the player input 34 can be combined into a single touch screen display that can display various states during a game as discussed in detail herein and will prompt the player for input as needed and allow for other player input as desired. In the remaining description, the display output 32 and player input 34 may be referred to as separate devices/functions, but it should be recognized that the two functions can be integrated into one device.

The central processor unit can be connected to a network 36 that allows data to be collected from the central processor unit 30 that can relate to the number of hands played at the gaming table and/or other data that is desirable by a casino manager. In addition, the network 36 can be utilized for programming a programming module 38 of the central processor unit 30 for remotely updating the gaming table programming. Additional sensors 40 can also be provided in communication with the central processor unit 30 as desired. The central processor unit 30 can be in the form of a computer processor, dedicated circuitry or other known control systems that can perform any or all of the following described features.

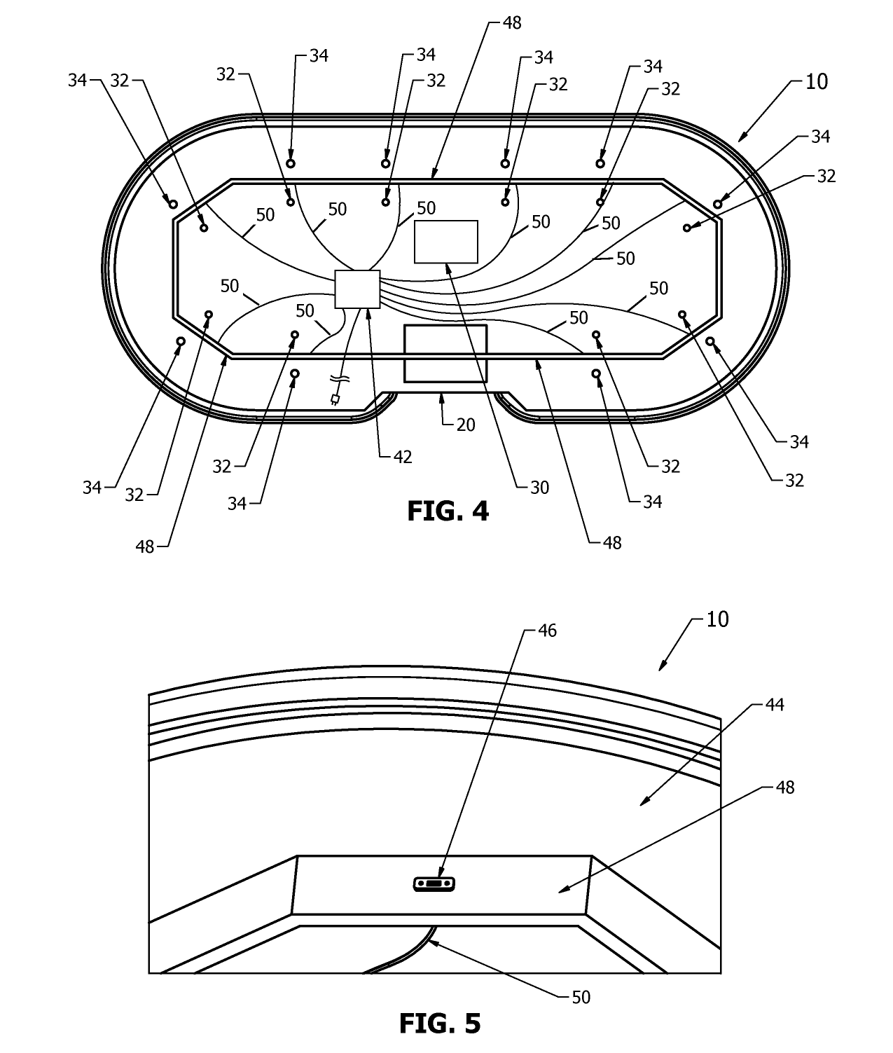

With reference to FIGS. 4-6, the gaming table 10 can be provided with a power supply 42 that can be mounted to an underside 44 of the table 10 as shown in FIG. 4. The power supply 42 can be connected to a plurality of charging ports 46 (10 of which are shown in FIG. 4) that can be utilized for charging phones, MP3 players and other electronic devices. With reference to FIG. 5, an exemplary charging port 46 is shown provided in a rail 48 provided on the underside 44 of the table 10. The charging ports 44 are connected to the power supply 42 by wires 50.

In operation, the gaming table 10 utilizes the display outputs 32₁₋₁₀ to indicate which player is “on the button” (i.e. the “dealer” for that hand). The dealer can utilize the index button 26 to index the display outputs to be lit, one after another, in a clockwise manner around the table 10 for each successive hand that is dealt. The player active switches 24 can be in the form of toggle switches and can be operated by the dealer to activate which of the player stations 14 are being occupied at the gaming table 10. The input from the player active switches 24 to the central processor unit 30 allows the central processor unit 30 to deactivate the display outputs 32 for the player stations 14 that are unoccupied at the table so that the index button 26 will cause the display outputs 32 to index only to display outputs 32 for player stations 14 that are being occupied. The display outputs 32 can also be activated to different colors or otherwise indicate an open playing station at the table. By adding the electronic system to gaming tables, the amount of mistakes and misdeals should be reduced creating a more efficient and enjoyable game experience. It should be understood that the central processor unit 30 can be customizable to allow using the system on a variety of card games, including but not limited to: poker, blackjack, three card poker and PaiGow.

During play at the gaming table 10, the charging ports 46 are conveniently located at each player station 14 so that each player has the opportunity to maintain their cell phone and other electronic devices in a charged state without having to leave the table to check on their devices. Therefore, the charging ports 46 allow for a more enjoyable game experience. Although the charging ports 46 are shown integrated in the rail 48 on the underside 44 of the table 10, the charging ports 46 can be implemented in the base 18 or in the rail 14 or playing surface 12, if desired.

The programmable central processor unit 30 allows for different modes so that a dealer can switch from different games or graphic displays during play at the gaming table 10. The different modes can provide for customized inputs by the players utilizing the player input 34₁₋₁₀ and for customized display via the display outputs 32₁₋₁₀ not only to indicate the dealer position, but also small blind, and big blind, as well as other types of information. The display devices 32 can be in the form of a simple mono colored light, or multicolored lights such as white, red, green and blue LEDs that can be selectively activated according to the game programming. By way of non-limiting example, a configuration for poker can utilize lights at each player position to display a variety of colors and signals (blinking, on, off, fading, flashing etc.). With the use of multicolored lights, a color that can be representative of the “dealer” can be for example “white”, while a color that can be representative of small blind can be, for example, “green” and a color that can be representative of big blind can be, for example, “blue”, while a color that can be representative of straddle can be, for example, “red”. As noted above the display output devices 32 can also be in the form of a visual display device and a touch screen visual display device that can also serve a dual function of the player input device 34 as well. The display devices 32 can also be used to indicate whose turn it is at the table. In addition, the central processor unit 30 can be used in a timer mode wherein a clock is called on a play and the dealer can activate the clock mode to display a blinking or other light pattern or a visual display in front of the player that needs to act.

As a further alternative, one or more display monitors 60 can be connected to the central processor unit 30 and can be provided at the center or other location on or near the table and can be used for indicating which station at the table is “on the button” or other similar game related information as discussed above. In addition, the display monitor 60 can optionally display the game being played, the betting requirements for the table and other advertising or game related information that can be entered into the central processor unit 30 for display.

The player inputs 34₁₋₁₀ allow each player to have a means to input game related information to the controller including but not limited to, a raise, fold, straddle, or other actions and can be used as a “call light” for wait staff so that the player does not need to look around the room in order to get the attention of a waiter or waitress. As an alternative, the players can request that the dealer activate their “call light” via the dealer control panel 22. The player inputs 34₁₋₁₀ can also be utilized to indicate that a seat at a player station 14 is occupied. The player inputs 34 can be otherwise programmable for allowing other inputs as desired for a particular poker tournament, casino or game.

Although the index switch 26 is shown as a pushbutton on the dealer control panel 22, it should be understood that the index switch 26 could be in the form of a foot switch that can be operated by the dealer under the table 10. It should also be understood that the dealer control panel 22 can be in the form of a touch screen control panel that can take various inputs for selecting different games, activating the various player stations to indicate which stations are occupied and to display various menus for game options and for following or directing various game and set-up procedures. The touch screen control panel could serve as an input device identifying the dealer name, player names, the game being played, the betting stakes and other relevant information related to the game.

The sensors 40 as shown in FIG. 6 can take on various forms including motion sensors, chair sensors, ring sensors and chip detectors that can be employed at the gaming table 10. It is anticipated that the use of interactive sensors, display lights and/or display monitors at a gaming table will lead to other gaming functions and conveniences that will enhance the gaming experience in various ways. For example, the use of multi-colored LEDs as the display devices 32 can be operated to flash and blink in organized fashion to indicate openings at the table, to provide entertainment, or to flash synchronously to music or in another attention gathering manner.

The gaming table 10 can also be used for self-deal games (i.e. without a designated dealer) where the player input buttons 34 at each player station 14 are activated to allow each player to index the “on the button”/“dealer” light to be indexed around the table without requiring input from the dealer control panel 22. In self-deal games, the player input buttons 34 can also be held down at the start of a game in order to indicate to the central processor unit 30 which player stations 14 are active so that the indexing of the dealer light automatically skips the unoccupied player stations 14. The central processing unit 30 can activate the display outputs 32 at each player station that is occupied (for example by temporarily blinking lights) so that the players can confirm that they have been properly recognized.

By way of example, a “blind bet” or just “blind” is a forced bet placed into the pot by one or more players before the deal begins, in a way that simulates bets made during play. A straddle bet is an optional and voluntary blind bet made by a player after the posting of the small and big blinds, but before cards are dealt. Straddles are typically used only in cash games played with fixed blind structures. The purpose of a straddle is to “buy” the privilege of last action, which on the first round with blinds is normally the player in the big blind. With the gaming table 10 according to the present disclosure, the player input buttons 34 can be used to activate the straddle and/or the restraddle option when in turn. Each player can press their corresponding player input button 34 once to turn on and again to turn off the “red” straddle light indicator 32. Once the button is indexed, the straddle players have three seconds to press the straddle button. An ‘auto straddle’ feature is provided where the players can press the player input button 34 to turn on the button light then whenever the big blind comes around to their right the red display light will automatically emit. The index button and blinds move, then all other lights that are not on AUTO straddle will blink for 3 seconds. In that time, the players in order can turn on the straddle so that it will change from blinking to solid straddle color (for example, RED).

As an optional timer function, if all but one active player holds their button for four seconds at the same time, it will activate timer countdown for the last seat to not hold the button, forcing that player to act within the timer countdown.

As a further optional function, the player input buttons 34 can be used in a game show style manner where the players can be asked a trivia question or otherwise prompted to hit their player input buttons 34 and whoever hits their button 34 first will have their indicator 32 light up. A random light sequence mode can also be utilized where a dealer starts a light that chases around the table clockwise very fast and slows down like a wheel would and then stops randomly at one of the active seats. This random light sequence can be utilized to select the first dealer in a game in an entertaining manner.

During gameplay, there are two modes of poker games that may make use of a dealer button and blinds. The first is a dealer button mode in which the system is turned on and all lights are blinking on and off. The dealer switches each active player to on or off as needed and the blinking lights are now only blinking for seats that are switched to on. Once all the active seats are turned on, the dealer can hold the index button-down for five seconds. All lights for seats that are active are then red. The dealer can then determine which seat will start with the “button” by dealing high card or with the random light sequence mode discussed above can select the first dealer. The dealer indexes the red light to the seat that wins the button. The dealer holds the index button-down again for five seconds and all lights turn off while the blinking red at the “dealer” position turns solid white and the small and big blinds light up in sequence. Play begins and once the hand of poker is complete the dealer indexes the “button” to the next active seat by momentarily pressing the index button 26 or depressing the foot switch. Players can also index the button by the current “dealer button” and next position holding the player input button 34 for one second at the same time.

During the straddle button mode game play, operation is the same as above but the player input button 34 at each seat will activate the straddle option when in turn.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A gaming table, comprising:
a playing surface having a plurality of player stations, each of said player stations having an indicator device that can be activated; and
a processor unit and at least one input device associated with the processor unit for selectively activating the indicator devices at each player station.

2. The gaming table according to claim 1, wherein the at least one input device includes a dealer control panel.

3. The gaming table according to claim 2, wherein the dealer control panel includes an index button for indexing the activation of the indicator devices to successive player stations during play.

4. The gaming table according to claim 3, wherein the dealer control panel includes a plurality of active player switches associated with each of said plurality of player stations and being operable for indicating to the processor unit which player stations are occupied during a game, wherein said processor unit causes said indexing of the activation of the indicator devices to skip the player stations that are not occupied.

5. The gaming table according to claim 2, wherein the gaming table is a poker table.

6. The gaming table according to claim 1, wherein the gaming table is a poker table.

7. The gaming table according to claim 1, wherein each of said player stations includes a charging port associated therewith for allowing a player to charge an electronic device at the gaming table.

8. A gaming table, comprising:
a playing surface having a plurality of player stations, said playing surface having an electronic indicator system that can be activated to indicate which player station is the dealer; and
a processor unit and at least one input device associated with the processor unit for selectively activating the electronic indicator system to change an indication of which player station is the dealer.

9. The gaming table according to claim 8, wherein the at least one input device includes a dealer control panel.

10. The gaming table according to claim 9, wherein the dealer control panel includes an index button for indexing the activation of the indicator system to indicate successive player stations as the dealer during play.

11. The gaming table according to claim 8, wherein the gaming table is a poker table.

12. The gaming table according to claim 8, wherein each of said player stations includes a charging port associated therewith for allowing a player to charge an electronic device at the gaming table.

13. A gaming table, comprising:
a playing surface having a plurality of player stations, each of said player stations having a charging port associated therewith for allowing a player to charge an electronic device at the gaming table.

14. The gaming table according to claim 13, wherein said charging port is integrated into a rail under the playing surface.

15. The gaming table according to claim 13, wherein the gaming table is a poker table.

16. A gaming table, comprising:
a playing surface having a plurality of player stations, said playing surface having an indicator device; and
a processor unit and at least one input device associated with the processor unit for selectively activating the indicator device to indicate which player station is active.

17. The gaming table according to claim 16, wherein the indicator device is a display monitor.

18. The gaming table according to claim 16, wherein the indicator device includes a plurality of indicator lights positioned, one each, at said plurality of player stations.
